(19) United States
(12) Patent Application Publication
(10) Pub. No.: US 2013/0302668 A1
(43) Pub. Date: Nov. 14, 2013

(54) ELECTROLYTE FOR SECONDARY BATTERY AND THE SECONDARY BATTERY COMPRISING THE SAME

(71) Applicant: LG Chem, Ltd., Seoul (KR)

(72) Inventors: SooHyun LIM, Daejeon (KR); YounKyoung LEE, Seoul (KR)

(21) Appl. No.: 13/865,502

(22) Filed: Apr. 18, 2013

(30) Foreign Application Priority Data
Apr. 18, 2012 (KR) 10-2012-0040608

(51) Int. Cl. H01M 10/056; H01M 10/052

(52) U.S. Cl. CPC H01M 10/056; H01M 10/052
USPC 429/200; 429/188; 429/199

(57) ABSTRACT

Disclosed are an electrolyte for a secondary battery which includes a non-aqueous solvent and a lithium salt and a secondary battery including the same. The electrolyte includes 1 to 13 wt % of a silane-based compound based on a total weight of the electrolyte and thus improves safety of a secondary battery including the electrolyte.

### TECHNICAL FIELD

The present invention relates to an electrolyte for a secondary battery which includes a non-aqueous solvent and a lithium salt and a secondary battery including the same. More specifically, the present invention relates to an electrolyte for a secondary battery that includes 1 to 13 wt % of a silane-based compound based on a total weight of the electrolyte and thus enhances safety of a secondary battery including the electrolyte and a secondary battery including the same.

### BACKGROUND ART

As mobile device technology continues to develop and demand therefor continues to increase, demand for secondary batteries as energy sources is rapidly increasing. Among these secondary batteries, lithium secondary batteries, which exhibit high energy density and operating potential, have long cycle lifespan, and have a low self-discharge rate, are commercially available and widely used.

In addition, as recent interest in environmental problems is increasing, research into electric vehicles (EVs), hybrid electric vehicles (HEVs), and the like that can replace vehicles using fossil fuels, such as gasoline vehicles, diesel vehicles, and the like, which are one of the main causes behind air pollution, is actively conducted. As a power source of EVs, HEVs, and the like, a nickel-metal hydride (Ni-MH) secondary battery is mainly used. However, research into lithium secondary batteries having high energy density, high discharge voltage, and high output stability is actively carried out and some of the lithium secondary batteries are commercially available.

A lithium secondary battery has a structure in which an electrode assembly, which includes: a cathode prepared by coating a cathode active material on a cathode current collector; an anode prepared by coating an anode active material on an anode current collector; and a porous separator disposed between the cathode and the anode, is impregnated with a lithium salt-containing non-aqueous electrolyte.

Currently, carbonaceous materials are mainly used to form anodes for lithium secondary batteries. However, the carbonaceous materials have a low electric potential of 0 V with respect to lithium and thus cause electrolyte reduction, generating gas. To address this problem, lithium titanium oxide (LTO) having a relatively high electric potential is used as an anode active material.

When the LTO is used, however, a large amount of hydrogen gas is generated during an activation process and charge-discharge processes and thus secondary battery safety is reduced.

Therefore, there is a need to develop a technology that can resolve the above-described problems.

### DISCLOSURE

### Technical Problem

Therefore, the present invention has been made to solve the above problems and other technical problems that have yet to be resolved.

As a result of a variety of extensive and intensive studies and experiments, the inventors of the present invention found that when an electrolyte for a secondary battery which includes a small amount of a silane-based compound is used, desired effects may be achieved, thus completing the present invention.

### Technical Solution

In accordance with one aspect of the present invention, provided is an electrolyte for a secondary battery which includes a non-aqueous solvent and a lithium salt, wherein the electrolyte includes 1 to 13 wt % of a silane-based compound based on a total weight of the electrolyte and thus a secondary battery including the electrolyte has improved safety.

As described above, decomposition of the electrolyte is accelerated due to side reaction between an electrode and the electrolyte and, as a result, gas is generated. Due to such gas, problems in terms of safety, e.g., swelling or explosion of a secondary battery, occur.

To address these problems, the electrolyte for a secondary battery according the present invention includes a silane-based compound.

In one embodiment, the silane-based compound may be represented by Formula a below:

R₁—Si(R₂)(R₃)—R₄ (a)
wherein at least one of R₁, R₂, R₃, and R₄ may each independently be hydrogen, a halogen, alkylamino, dialkylamino, alkyl alcohol, C₁-C₂₀ alkyl, C₁-C₂₀ alkenyl, C₁-C₂₀ alkynyl, C₁-C₂₀ alkoxy, C₁-C₂₀ alkoxycarbonyl, C₁-C₂₀ acyl, C₃-C₂₀ cycloalkyl, C₂-C₁₈ allyl, C₆-C₁₈ aryl, nitrile, silazane, or phosphate.

Among substituents of the silane-based compound, at least one of R₁, R₂, and R₃ is bonded to a surface of an electrode active material to form a film. In this regard, the remainders thereof that do not participate in film formation on the surface of the electrode active material and R₄ are directed toward the electrolyte, and thus, side reaction between the electrode active material and the electrolyte is prevented and therefore decomposition of the electrolyte may be suppressed.

More specifically, in the silane-based compound of Formula a, at least one of R₁, R₂, and R₃ may be a halogen, silazane, C₁-C₂₀ alkoxy, C₆-C₁₈ aryl, or C₂-C₁₈ allyl, and R₄ may be C₁-C₂₀ alkyl, nitrile, fluorine, or phosphate. In this case, R₁, R₂, and R₃ may form a film on the surface of the electrode active material, and R₄ may be directed toward the electrolyte.

In particular, in the silane-based compound of Formula a, R₁ and R₂ may be a halogen, silazane, C₁-C₂₀ alkoxy, C₆-C₁₈ aryl, or C₂-C₁₈ allyl, and R₃ and R₄ may be C₁-C₂₀ alkyl, nitrile, fluorine, or phosphate. In this case, R₁ to R₃ may form a film on the surface of the electrode active material, and R₄ may be directed toward the electrolyte.

In another embodiment, at least one of R₁, R₂, and R₃ of the silane-based compound of Formula a may be C₁-C₂₀ alkyl or C₁-C₂₀ alkoxy, and R₄ may be silazane.

In particular, the silane-based compound of Formula a may be hexamethyldisilazane represented by (Si(CH₃)₃)₂NH.

The term “silazane” as used herein collectively refers to compounds having a Si—Ni—Si bond, and examples of the silazane include disilazane and trisilazane, divided according to number of silicon atoms.

The other substituents as used herein, i.e., alkylamino, dialkylamino, alkyl, alkenyl, alkynyl, alkoxy, alkoxy carbonyl, acyl, cycloalkyl, aryl, and the like are generally known to one of ordinary skill in the art, and thus, a detailed description thereof is omitted.

The amount of the silane-based compound in the electrolyte for a secondary battery may be 4 to 11 wt % based on the total weight of the electrolyte. When the amount of the silane-based compound is too small, sufficient safety may not be obtained. On the other hand, when the amount of the silane-based compound is too large, safety of a secondary battery including the electrolyte may be improved while the amount of the lithium salt is relatively small, and thus, overall characteristics of the secondary battery may be deteriorated.

The present invention also provides a secondary battery including the electrolyte described above.

The secondary battery according to the present invention includes a cathode, which is prepared by coating a mixture of a cathode active material, a conductive material, and a binder on a cathode current collector and drying and pressing the coated cathode current collector, and an anode prepared using the same method as that used to manufacture the cathode. In this case, the mixture may further include a filler as desired.

The cathode current collector is generally fabricated to a thickness of 3 to 500 μm. The cathode current collector is not particularly limited so long as it does not cause chemical changes in the fabricated secondary battery and has high conductivity. For example, the cathode current collector may be made of stainless steel, aluminum, nickel, titanium, sintered carbon, or aluminum or stainless steel surface-treated with carbon, nickel, titanium, silver, or the like. The cathode current collector may have fine irregularities at a surface thereof to increase adhesion between a cathode active material and the cathode current collector. In addition, the cathode current collector may be used in any of various forms including films, sheets, foils, nets, porous structures, foams, and non-woven fabrics.

Examples of the cathode active material include, but are not limited to, layered compounds such as lithium cobalt oxide (LiCoO₂) and lithium nickel oxide (LiNiO₂), or compounds substituted with one or more transition metals; lithium manganese oxides such as compounds of Formula Li₁₊ₓMn₂₋ₓO₄ where 0≦x≦0.33, LiMnO₃, LiMn₂O₃, LiMnO₂; lithium copper oxide (Li₂CuO₂); vanadium oxides such as LiV₃O₈, LiV₃O₄, V₂O₅, and Cu₂V₂O₇; Ni-site type lithium nickel oxides having the formula LiNi₁₋ₓMₓO₂ where M=Co, Mn, Al, Cu, Fe, Mg, B, or Ga, and 0.01≦x≦0.3; lithium manganese composite oxides having the formula LiMn₂₋ₓMₓO₂ where M=Co, Ni, Fe, Cr, Zn, or Ta, and 0.01≦x≦0.1 or the formula Li₂Mn₃MO₈ where M=Fe, Co, Ni, Cu, or Zn; spinel-structure lithium manganese composite oxides represented by LiNiₓMn₂₋ₓO₄; LiMn₂O₄ where some of the Mn atoms are substituted with alkaline earth metal ions; disulfide compounds; and Fe₂(MoO₄)₃. Specifically, the cathode active material may be a spinel-structure lithium metal oxide represented by Formula 1 below:

LiₓM_{y}Mn_{2-y}O_{4-z}A_{z} (1)

wherein 0.9≦x≦1.2, 0<y<2, and 0≦z<0.2; M refers to at least one element selected from the group consisting of Al, Mg, Ni, Co, Fe, Cr, V, Ti, Cu, B, Ca, Zn, Zr, Nb, Mo, Sr, Sb, W, Ti, and Bi; and A is at least one monovalent or divalent anion.

More specifically, the spinel-structure lithium metal oxide may be represented by Formula 2 below:

LiₓNi_{y}Mn_{2-y}O₄ (2)

wherein 0.9≦x≦1.2 and 0.4≦y≦0.5.

More particularly, the spinel-structure lithium metal oxide may be LiNi_{0.5}Mn_{1.5}O₄ or LiNi_{0.4}Mn_{1.6}O₄.

The conductive material is typically added in an amount of 1 to 50 wt % based on the total weight of the mixture including the cathode active material. There is no particular limit as to the conductive material, so long as it does not cause chemical changes in the fabricated battery and has conductivity. Examples of conductive materials include graphite such as natural or artificial graphite; carbon black such as carbon black, acetylene black, Ketjen black, channel black, furnace black, lamp black, and thermal black; conductive fibers such as carbon fibers and metallic fibers; metallic powders such as carbon fluoride powder, aluminum powder, and nickel powder; conductive whiskers such as zinc oxide and potassium titanate; conductive metal oxides such as titanium oxide; and polyphenylene derivatives.

The binder is a component assisting in binding between the electrode active material and the conductive material and in binding of the electrode active material to the cathode current collector. The binder is typically added in an amount of 1 to 50 wt % based on the total weight of the mixture including the cathode active material. Examples of the binder include polyvinylidene fluoride, polyvinyl alcohols, carboxymethylcellulose (CMC), starch, hydroxypropylcellulose, regenerated cellulose, polyvinyl pyrrolidone, tetrafluoroethylene, polyethylene, polypropylene, ethylene-propylene-diene terpolymer (EPDM), sulfonated EPDM, styrene butadiene rubber, fluorine rubber, and various copolymers.

The filler is optionally used as a component to inhibit cathode expansion. The filler is not particularly limited so long as it is a fibrous material that does not cause chemical changes in the fabricated battery. Examples of the filler include olefin-based polymers such as polyethylene and polypropylene; and fibrous materials such as glass fiber and carbon fiber.

An anode current collector is typically fabricated to a thickness of 3 to 500 μm. The anode current collector is not particularly limited so long as it does not cause chemical changes in the fabricated secondary battery and has conductivity. For example, the anode current collector may be made of copper, stainless steel, aluminum, nickel, titanium, sintered carbon, copper or stainless steel surface-treated with carbon, nickel, titanium, or silver, and aluminum-cadmium alloys. Similar to the cathode current collector, the anode current collector may also have fine irregularities at a surface thereof to enhance adhesion between the anode current collector and an anode active material. In addition, the anode current collector may be used in various forms including films, sheets, foils, nets, porous structures, foams, and non-woven fabrics.

Examples of the anode active material include carbon such as hard carbon and graphite-based carbon; metal composite oxides such as LiₓFe₂O₃where 0≦x≦1, LiₓWO₂ where 0≦x≦1, and SnₓMe₁₋ₓMe′_{y}O_{z} where Me: Mn, Fe, Pb or Ge; Me′: Al, B, P, Si, Group I, Group II and Group III elements, or halogens; 0<x≦1; 1≦y≦3; and 1≦z≦8); lithium metals; lithium alloys; silicon-based alloys; tin-based alloys; metal oxides such as SnO, SnO₂, PbO, PbO₂, Pb₂O₃, Pb₃O₄, Sb₂O₃, Sb₂O₄, Sb₂O₅, GeO, GeO₂, Bi₂O₃, Bi₂O₄, and Bi₂O₅; conductive polymers such as polyacetylene; and Li—Co—Ni based materials. In particular, a lithium metal oxide represented by Formula 3 below may be used.

LiₐM′_{b}O_{4-c}A_{c} (3)

wherein M′ is at least one element selected from the group consisting of Ti, Sn, Cu, Pb, Sb, Zn, Fe, In, Al, and Zr; 0.1≦a≦4 and 0.2≦b≦4 wherein a and b are determined according to oxidation number of M′; 0≦c<0.2 wherein c is determined according to oxidation number of A; and A is at least one monovalent or divalent anion.

The lithium metal oxide of Formula 3 may be represented by Formula 4 below:

LiₐTi_{b}O₄ (4)

wherein 0.5≦a≦3 and 1≦b≦2.5.

More particularly, the lithium metal oxide may be Li_{1.33}Ti_{1.67}O₄ or LiTi₂O₄.

In one embodiment, lithium titanium oxide (LTO), which has low electronic conductivity, may be used as the anode active material. In addition, in this case, a spinel-structure lithium manganese composite oxide having the formula LiNiₓMn₂₋ₓO₄ where x=0.01 to 0.6 that has a relatively high electric potential due to high electric potential of LTO may be used as the cathode active material.

In embodiments of the present invention, the silane-based compound included in the electrolyte reacts with the electrode active material, and thus, gas discharge and generation of by-products, caused by decomposition of the electrolyte that occurs since the LTO acts as a catalyst and oxidation of the electrolyte that occurs due to reaction between the spinel-structure lithium manganese composite oxide and the electrolyte, may be prevented.

The secondary battery having the above-described structure may have a structure in which an electrode assembly including a cathode, an anode, and a separator disposed therebetween is impregnated with a lithium salt-containing electrolyte.

The separator is disposed between the cathode and the anode and, as the separator, an insulating thin film having high ion permeability and mechanical strength is used. The separator typically has a pore diameter of 0.01 to 10 μm and a thickness of 5 to 300 μm. As the separator, sheets or non-woven fabrics made of an olefin polymer such as polypropylene, glass fibers or polyethylene, which have chemical resistance and hydrophobicity, are used. When a solid electrolyte such as a polymer is employed as the electrolyte, the solid electrolyte may also serve as both the separator and electrolyte.

The lithium salt-containing electrolyte is composed of an electrolyte and a lithium salt. As the electrolyte, a non-aqueous organic solvent, an organic solid electrolyte, or an inorganic solid electrolyte may be used, but embodiments of the present invention are not limited thereto.

For example, the non-aqueous organic solvent may be an aprotic organic solvent such as N-methyl-2-pyrrolidone, propylene carbonate, ethylene carbonate, butylene carbonate, dimethyl carbonate, diethyl carbonate, gamma butyrolactone, 1,2-dimethoxy ethane, tetrahydroxy franc, 2-methyl tetrahydrofuran, dimethylsulfoxide, 1,3-dioxolane, formamide, dimethylformamide, dioxolane, acetonitrile, nitromethane, methyl formate, methyl acetate, phosphoric acid triester, trimethoxy methane, dioxolane derivatives, sulfolane, methyl sulfolane, 1,3-dimethyl-2-imidazolidinone, propylene carbonate derivatives, tetrahydrofuran derivatives, ether, methyl propionate, or ethyl propionate.

Examples of the organic solid electrolyte include polyethylene derivatives, polyethylene oxide derivatives, polypropylene oxide derivatives, phosphoric acid ester polymers, poly agitation lysine, polyester sulfide, polyvinyl alcohols, polyvinylidene fluoride, and polymers containing ionic dissociation groups.

Examples of the inorganic solid electrolyte include nitrides, halides and sulfates of lithium such as Li₃N, LiI, Li₅NI₂, Li₃N-LiI—LiOH, LiSiO₄, LiSiO₄—LiI—LiOH, Li₂SiS₃, Li₄SiO₄, Li₄SiO₄—LiI—LiOH, and Li₃PO₄—Li₂S—SiS₂.

The lithium salt is a material that is readily soluble in the non-aqueous electrolyte and examples thereof include LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, (CF₃SO₂)₂NLi, chloroborane lithium, lower aliphatic carboxylic acid lithium, lithium tetraphenyl borate, and imide.

In addition, in order to improve charge/discharge characteristics and flame retardancy, for example, pyridine, triethylphosphite, triethanolamine, cyclic ether, ethylenediamine, n-glyme, hexaphosphoric triamide, nitrobenzene derivatives, sulfur, quinone imine dyes, N-substituted oxazolidinone, N,N-substituted imidazolidine, ethylene glycol dialkyl ether, ammonium salts, pyrrole, 2-methoxy ethanol, aluminum trichloride, or the like may be added to the electrolyte. In some cases, in order to impart incombustibility, the electrolyte may further include a halogen-containing solvent such as carbon tetrachloride and ethylene trifluoride. In addition, in order to improve high-temperature storage characteristics, the electrolyte may further include carbon dioxide gas, fluoro-ethylene carbonate (FEC), propene sultone (PRS), or the like.

In one embodiment, a lithium salt-containing non-aqueous electrolyte may be prepared by adding a lithium salt such as LiPF₆, LiClO₄, LiBF₄, LiN(SO₂CF₃)₂, or the like to a mixed solvent including EC or PC, which is a high dielectric solvent and a cyclic carbonate, and DEC, DMC, or EMC, which is a low viscosity solvent and a linear carbonate.

The present invention also provides a battery module including the secondary battery as a unit battery and a battery pack including the battery module.

The battery pack may be used as a power source for medium and large devices that require stability at high temperature, long cycle life, and high rate characteristics.

Examples of such medium and large devices include, but are not limited to, electric motor-driven power tools; electric vehicles (EVs), hybrid electric vehicles (HEVs), and plug-in hybrid electric vehicles (PHEVs); electric two-wheeled vehicles such as e-bikes and e-scooters; electric golf carts; and systems for storing power.

### Effects of Invention

As apparent from the fore-going, the present invention provides an electrolyte for a secondary battery that includes a small amount of a silane-based compound and thus may prevent gas discharge and generation of by-products, which are caused by oxidation of the electrolyte through charge and discharge processes of a battery. Accordingly, a secondary battery including the electrolyte may exhibit high safety.

### BRIEF DESCRIPTION OF THE DRAWINGS

The above and other objects, features and other advantages of the present invention will be more clearly understood from the following detailed description taken in conjunction with the accompanying drawing, in which:

FIG. 1 is a graph showing measurement results of the amount of gas generated in secondary batteries manufactured according to Experimental Example 1.

### BEST MODE

Now, the present invention will be described in more detail with reference to the following examples. These examples are provided only for illustration of the present invention and should not be construed as limiting the scope and spirit of the present invention.

### EXAMPLE 1

An electrolyte for a secondary battery was prepared by adding hexamethyldisilazane to a lithium non-aqueous electrolyte including 1M LiPF₆ in a mixed solution of EC/DMC/EMC in a volume ratio of 1:1:1, in an amount of 10 wt % based on a total weight of the electrolyte.

### EXAMPLE 2

An electrolyte for a secondary battery was prepared in the same manner as in Example 1, except that the amount of hexamethyldisilazane added was 5 wt % based on the total weight of the electrolyte.

### COMPARATIVE EXAMPLE 1

An electrolyte for a secondary battery was prepared in the same manner as in Example 1, except that the amount of hexamethyldisilazane added was 15 wt % based on the total weight of the electrolyte.

### COMPARATIVE EXAMPLE 2

An electrolyte for a secondary battery was prepared in the same manner as in Example 1, except that the silane-based compound was not used as an additive.

### EXPERIMENTAL EXAMPLE 1

Secondary batteries were manufactured using the electrolytes for secondary batteries prepared according to Examples 1 and 2 and Comparative Examples 1 and 2 as follows.

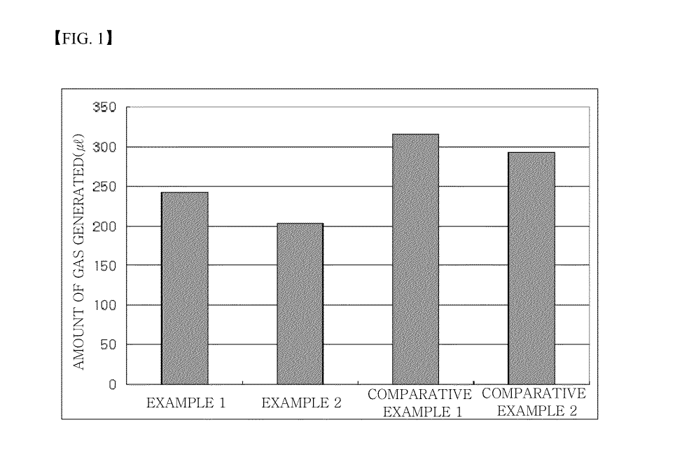

First, 90 wt % of LiNi_{0.5}Mn_{1.5}O₄ as a cathode active material, 5 wt % of Super-C as a conductive material, and 5 wt % of PVdF as a binder were added to NMP to prepare a cathode material, the cathode material was coated on an Al current collector, and the coated Al current collector was dried and pressed, thereby preparing a cathode for each secondary battery. Subsequently, 90 wt % of Li_{1.33}Ti_{1.67}O₄, 5 wt % of Super-C as a conductive material, and 5 wt % of PVdF as a binder were added to NMP to prepare an anode material, the anode material was coated onto an Al current collector, and the coated Al current collector was dried and pressed, thereby preparing an anode for each secondary battery, and a porous separator made of polypropylene was disposed between the cathode and the anode, thereby completing manufacture of an electrode assembly. Thereafter, the electrode assembly was placed in a pouch to which lead wires were then connected, each of the electrolytes for secondary batteries of Examples 1 and 2 and Comparative Examples 1 and 2 was injected into the pouch, followed by sealing the pouch, thereby completing assembly of each lithium secondary battery. The secondary batteries were stored at 55° C. for 4 weeks after being subjected to charge/discharge cycles, and the amount of gas generated by each secondary battery was measured and measurement results are illustrated in FIG. 1.

Referring to FIG. 1, the secondary batteries of Examples 1 and 2 exhibited less gas generation than the secondary battery of Comparative Example 1 including an excess amount of the silane-based compound and the secondary battery of Comparative Example 2 without including the silane-based compound, which indicates high safety of the secondary batteries according to the present invention.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An electrolyte for a secondary battery, comprising a lithium salt, the electrolyte comprising 1 to 13 wt % of a silane-based compound based on a total weight of the electrolyte to improve safety of the secondary battery.

2. The electrolyte according to claim 1, wherein the silane-based compound is represented by Formula a below:
R₁—Si(R₂)(R₃)—R₄ (a)
wherein at least one selected from R₁, R₂, R₃, and R₄ are each independently hydrogen, a halogen, alkylamino, dialkylamino, alkyl alcohol, C₁-C₂₀ alkyl, C₁-C₂₀ alkenyl, C₁-C₂₀ alkynyl, C₁-C₂₀ alkoxy, C₁-C₂₀ alkoxycarbonyl, C₁-C₂₀ acyl, C₃-C₂₀ cycloalkyl, C₂-C₁₈ allyl, C₆-C₁₈ aryl, nitrile, silazane, or phosphate.

3. The electrolyte according to claim 2, wherein at least one selected from R₁ to R₃ of the silane-based compound of Formula a is a halogen, silazane, C₁-C₂₀ alkoxy, C₆-C₁₈ aryl, or C₂-C₁₈ allyl, and R₄ is C₁-C₂₀ alkyl, nitrile, fluorine, or phosphate.

4. The electrolyte according to claim 2, wherein R₁ and R₂ of the silane-based compound of Formula a are each independently a halogen, silazane, C₁-C₂₀ alkoxy, C₆-C₁₈ aryl, or C₂-C₁₈ allyl, and R₃ and R₄ are each independently C₁-C₂₀ alkyl, nitrile, fluorine, or phosphate.

5. The electrolyte according to claim 2, wherein at least one selected from R₁ to R₃ of the silane-based compound of Formula a is C₁-C₂₀ alkyl or C₁-C₂₀ alkoxy, and R₄ is silazne.

6. The electrolyte according to claim 5, wherein the silane-based compound of Formula a is hexamethyldisilazae.

7. The electrolyte according to claim 1, wherein an amount of the silane-based compound is in a range of 3 to 11 wt % based on the total weight of the electrolyte.

8. A secondary battery comprising the electrolyte according to claim 1.

9. The secondary battery according to claim 8, wherein the secondary battery comprises a spinel-structure lithium metal oxide represented by Formula 1 below as a cathode active material:
LiₓM_{y}Mn_{2-y}O_{4-z}A_{z} (1)
wherein 0.9≦x≦1.2, 0<y<2, and 0≦z<0.2;
M is at least one element selected from the group consisting of Al, Mg, Ni, Co, Fe, Cr, V, Ti, Cu, B, Ca, Zn, Zr, Nb, Mo, Sr, Sb, W, Ti, and Bi; and
A is at least one monovalent or divalent anion.

10. The secondary battery according to claim 9, wherein the spinel-structure lithium metal oxide is represented by Formula 2 below:
LiₓNi_{y}Mn_{2-y}O₄ (2)
wherein 0.9≦x≦1.2 and 0.4≦y≦0.5.

11. The secondary battery according to claim 10, wherein the spinel-structure lithium metal oxide is LiNi_{0.5}Mn_{1.5}O₄ or LiNi_{0.4}Mn_{1.6}O₄.

12. The secondary battery according to claim 8, wherein the secondary battery comprises a lithium metal oxide represented by Formula 3 below as an anode active material:
LiₐM′_{b}O_{4-c}A_{c} (3)
wherein M′ is at least one element selected from the group consisting of Ti, Sn, Cu, Pb, Sb, Zn, Fe, In, Al, and Zr;
0.1≦a≦4 and 0.2≦b≦4 wherein a and b are determined according to oxidation number of M′;
0≦c<0.2 wherein c is determined according to oxidation number of A; and
A is at least one monovalent or divalent anion.

13. The secondary battery according to claim 12, wherein the lithium metal oxide is represented by Formula 4 below:
LiₐTi_{b}O₄ (4)
wherein 0.5≦a≦3 and 1≦b≦2.5.

14. The secondary battery according to claim 13, wherein the lithium metal oxide is Li_{1.33}Ti_{1.67}O₄ or LiTi₂O₄.

15. The secondary battery according to claim 8, wherein the secondary battery is a lithium secondary battery.

16. A battery module comprising the secondary battery according to claim 15 as a unit cell.

17. A battery pack comprising the battery module according to claim 16.

18. A device comprising the battery pack according to claim 17.

19. The device according to claim 18, wherein the device is an electric vehicle, a hybrid electric vehicle, a plug-in hybrid electric vehicle, or a system for storing power.
